(19) United States
(12) Patent Application Publication
(10) Pub. No.: US 2025/0329974 A1
(43) Pub. Date: Oct. 23, 2025

(54) FORCE FEEDBACK CORRECTION FOR CABLE WIRE INSERTION

(71) Applicant: The Boeing Company, Arlington, VA (US)

(72) Inventors: Joshua Lampkins, Los Angeles, CA (US); Wyatt McAllister, Santa Monica, CA (US); Darren Chan, Thousand Oaks, CA (US)

(21) Appl. No.: 18/638,478

(22) Filed: Apr. 17, 2024

(51) Int. Cl. H01R 43/20

(52) U.S. Cl. CPC H01R 43/20

(57) ABSTRACT

A method for assembly of a cable connector includes, an end effector affixed to an articulated robot arm of a robotic insertion system, holding a cable wire for insertion into an insertion cavity of a connector housing. The articulated robot arm is controlled to move the cable wire toward a preliminary insertion pose predicted to correspond to insertion of the cable wire into the insertion cavity. Using a force sensor, the robotic insertion system detects that a magnitude of an insertion force vector exceeds an insertion force threshold, indicating misalignment of the cable wire relative to the insertion cavity. The articulated robot arm is controlled to move the cable wire toward a corrected insertion pose determined based at least in part on the insertion force vector, wherein the preliminary insertion pose and the corrected insertion pose differ by a pose adjustment.

### FIELD

The invention relates generally to robotic insertion techniques, and more particularly, techniques for assembly of connectors via robotic insertion of cable wires.

### BACKGROUND

Various types of connectors are often used to conductively couple one cable to another, and/or couple a cable to an electronic device, for transmission of data and/or power. The specific size, shape, and design of the connector used is often influenced by the type, purpose, and location of the cable to which the connector is attached, and this affects the manner in which the connector is manufactured and assembled.

### SUMMARY

This summary is not an extensive overview of the specification. It is intended to neither identify key or critical elements of the specification nor delineate any scope particular to embodiments of the specification, or any scope of the claims. Its sole purpose is to present some concepts of the specification in a simplified form as a prelude to the more detailed description that is presented in this disclosure.

A method for assembly of a cable connector includes, an end effector affixed to an articulated robot arm of a robotic insertion system, holding a cable wire for insertion into an insertion cavity of a connector housing. The articulated robot arm is controlled to move the cable wire toward a preliminary insertion pose predicted to correspond to insertion of the cable wire into the insertion cavity. Using a force sensor, the robotic insertion system detects that a magnitude of an insertion force vector exceeds an insertion force threshold, indicating misalignment of the cable wire relative to the insertion cavity. The articulated robot arm is controlled to move the cable wire toward a corrected insertion pose determined based at least in part on the insertion force vector, wherein the preliminary insertion pose and the corrected insertion pose differ by a pose adjustment.

The features, functions, and advantages that have been discussed can be achieved independently in various embodiments or can be combined in yet other embodiments, further details of which can be seen with reference to the following description and drawings.

### BRIEF DESCRIPTION OF THE DRAWINGS

FIG. 1 schematically depicts an example cable connector, including a cable housing into which a plurality of cable wires is inserted.

FIGS. 2A and 2B depict aspects of example modular cable connector assemblies.

FIG. 3 illustrates an example method for assembly of a cable connector.

FIG. 4 schematically illustrates use of a robotic insertion system to hold an example cable wire for insertion into a connector housing.

FIG. 5 schematically illustrates use of a robotic insertion system to hold an example cable wire module for insertion into a modular connector housing.

FIGS. 6A and 6B schematically show example images captured by a camera system of a robotic insertion system to identify a preliminary insertion pose.

FIGS. 7A-7D schematically illustrate a robotic insertion system performing insertion correction based on a force insertion vector.

FIG. 8 schematically shows an example computing system determining a pose adjustment based on an insertion force vector.

FIG. 9 schematically shows an example computing system.

### DETAILED DESCRIPTION

Construction of a cable connector typically involves one or more steps in which cable wires are inserted into insertion cavities of a connector housing. Such insertion may be done manually, such as by a human worker, and/or automatically, such as via suitable mechanical or robotic insertion systems. In either case, however, cable wire insertion can be time consuming and inconsistent. Attempts to automate cable wire insertion are complicated by the wide variety of different shapes and types of cable connectors. For instance, in some cases, cable wires may be inserted into connector housings as individual wires, and inserted into sockets (e.g., round sockets) within the connector housing. In some cases, one or more cable wires may be bundled together in a cable wire module, which may then be inserted into a corresponding slot in a modular connector housing.

Accordingly, the present disclosure is directed to techniques for automated cable wire insertion by a robotic insertion system that can beneficially facilitate consistent and accurate insertion of cable wires, and which may provide flexibility as to the types of cable wires and connector housings used. The techniques described herein include, using an end effector of an articulated robot arm, holding a cable wire for insertion into an insertion cavity of a connector housing. The articulated robot arm is controlled to move the cable wire toward a preliminary insertion pose. In some cases, the preliminary insertion pose is identified based on machine vision analysis of images captured by a camera system. However, this initial insertion attempt is not always successful—e.g., minor misalignments between the cable wire and connector housing can cause the cable wire to collide with an edge or surface of the connector housing, instead of being successfully inserted into an insertion cavity. According to the techniques described herein, such misalignment is indicated by an insertion force vector output by a force sensor exceeding an insertion force threshold. When this occurs, the articulated robot arm is controlled to move the cable wire toward a corrected insertion pose, which differs from the preliminary insertion pose by a pose adjustment. In some cases, this pose adjustment is determined dynamically—e.g., based on one or more adjustment parameters.

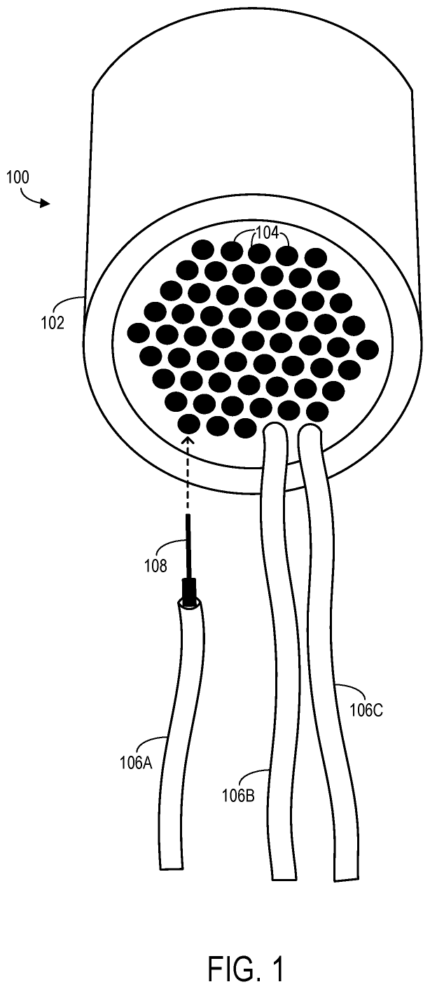

Cable wire insertion into a connector housing is schematically illustrated with respect to FIG. 1, showing an example cable connector 100. The cable connector includes a connector housing 102, which includes a plurality of insertion cavities into which cables can be inserted during assembly of the cable connector. Several insertion cavities are labeled in FIG. 1 as insertion cavities 104. Additionally, FIG. 1 depicts three different cable wires 106A, 106B, and 106C. Cable wires 106B and 106C have been inserted into respective insertion cavities of the connector housing, while cable wire 106A has yet to be inserted.

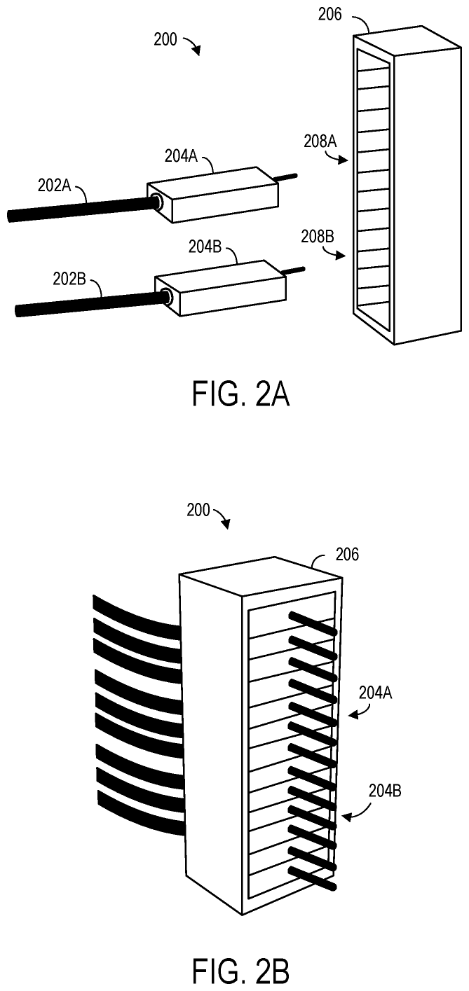

It will be understood that the specific components shown in FIG. 1, as well as the other FIGS. 2-9 described herein, are highly simplified for the sake of explanation. The sizes, shapes, and specific appearances of the components shown in FIGS. 1-9 are non-limiting and not drawn to scale. Furthermore, it will be understood that the components depicted in FIGS. 1-9 may be constructed from any suitable materials. For example, the connector housings, cable wires, cable contacts, and other components described herein may be constructed from any suitable combination of plastics and/or metals, as non-limiting examples.

In the example of FIG. 1, three different cable wires are shown, although it will be understood that any suitable number of different cable wires may be inserted into a connector housing. For instance, the number of inserted cable wires may be equal to, or less than, the number of insertion cavities in the connector housing. In other words, it will be understood that the specific configuration depicted in FIG. 1 is non-limiting, and that the techniques described herein may be applicable to cable connectors used to connect any suitable number of cable wires to one another, and/or to electronic devices such as printed circuit boards (PCBs).

The present disclosure primarily focuses on electrically conductive cable wires used to transmit electrical power and/or data. However, in some examples, the cable connectors described herein may be used with cable wires that are not electrically conductive, but include other suitable transmissive media, such as fiber optic cables.

As used herein, a “cable wire” includes a length of material used for transmission of data and/or power (e.g., copper wire, fiber optic), often coated with a protective material (e.g., plastic or rubber insulation, grounded shielding). In other words, the term “cable wire” may be used to refer to more than just the conductive (e.g., copper) or non-conductive (e.g., fiber optic) core of the cable, but may additionally refer to any coating, insulation, and/or shielding applied to the core.

A “cable” includes one or more different cable wires. In cases where a cable only includes one cable wire, then the terms “cable wire” and “cable” may be used interchangeably. However, in some examples, one cable includes two or more cable wires bundled together. For instance, in some embodiments, a cable is a multi-conductor cable including two or more cable wires—e.g., different conductive copper wires are each coated in their own respective insulated cable jackets, and also bundled together in additional insulation and/or shielding to form a multi-conductor cable. In some embodiments, a cable is a shielded twisted pair cable, in which different cable wires include pairs of conductors twisted together and protected by an insulating jacket. The twisted pairs are themselves bundled together and enclosed by additional shielding and/or insulation to form the shielded twisted pair cable. In cases where a cable includes two or more different cable wires, the different cable wires may each be inserted into different insertion cavities of the connector housing.

In general, there will be a correspondence between different specific cable wires and the insertion cavities into which the cable wires are inserted. For instance, different specific cable wires may have different purposes (e.g., to carry power, to carry data, to complete a ground connection), and thus may be inserted into different specific insertion cavities, such that the final cable connector can be used to couple the cable wires with the correct downstream components (e.g., ground points, input/output lines, power inlets). In some cases, the different cable wires have different distinguishable appearances—e.g., the cable wires may have different sizes (e.g., gauges), may use different colors or types of insulating/protective jackets, may use different materials for the cable wire core (e.g., different conductive metals or non-conductive materials), and/or may differ in any other suitable way.

In the example of FIG. 1, a conductive cable contact 108 is attached to the tip of cable wire 106A. In general, however, tips of the cable wires may be treated in any suitable way. For instance, in some examples, conductive contacts may be attached to the cable wire tips, where such contacts may have any suitable size and shape. Different types of conductive contacts may in some cases be attached to different cable wires inserted into the same connector housing. In some examples, cable wires need not include conductive contacts. Rather, for instance, a cable wire may terminate with an exposed length of the cable wire core, or in any other suitable way.

Each insertion cavity of the connector housing is sized and shaped for insertion of a cable wire. As shown, cable wires 106B and 106C are inserted into respective insertion cavities of the connector housing. The insertion cavities have any suitable size, based on the size of the cable intended for insertion into the insertion cavities. In some examples, the same connector housing may include different insertion cavity sizes intended for insertion of cable wires having different sizes (e.g., different wire gauges).

In some cases, the insertion cavity is sized to accommodate the insulation jacket surrounding the core of the cable wire (e.g., the copper wire or fiber optic material), such that some length of insulated cable is inserted into the connector housing. In other examples, the insulation jacket may be trimmed such that only the cable core is inserted into the connector housing.

Any suitable length of cable wire may be inserted into the connector housing. In general, the cable wire is inserted sufficiently far into the connector housing so as to enable transmission of data and/or power between the cable wire and any components that are coupled with the connector housing—e.g., other cable wires and/or electronic devices. Additionally, or alternatively, cable wires may be inserted sufficiently far such that retention mechanisms within the connector housing hold the cable wires in place.

As discussed above, in some examples, cables may be grouped together in cable modules, and then inserted into a modular connector housing. This is schematically illustrated with respect to FIGS. 2A and 2B. Specifically, FIG. 2A schematically shows aspects of an example modular cable connector assembly 200. This includes two different cable wires 202A and 202B. In this example, however, the cable wires have been inserted into different respective cable wire modules 204A and 204B. While in this example, only one cable wire is inserted into each cable wire module, it will be understood that this is non-limiting. Rather, in other examples, two or more different cable wires may each be inserted into the same cable wire module. In other words, a cable wire module may serve as a plug that bundles two or more different cable wires together.

Each cable wire module is sized and shaped for retention within a modular connector housing. In this manner, a stacked set of cable wire modules may each be retained within the same connector housing, where each module is in some cases attached to a different cable. This conveniently enables the populated connector housing to serve as a male plug and/or female receptacle for coupling the different cables with suitable other components—e.g., a similar populated connector housing attached to a second set of cables, and/or an electronic device such as a PCB.

In FIG. 2A, the cable connector assembly includes a connector housing 206 including a plurality of insertion cavities, two of which are labeled as insertion cavities 208A and 208B. In this example, the insertion cavities take the form of different slots within the connector housing, into which cable wire modules can be inserted and retained. Each insertion cavity may be described as a shelf or notch that holds an inserted module in place within the connector housing. Any suitable mechanism may be used to retain cable wire modules within insertion cavities of a modular connector housing. For instance, in one example, each cable wire module includes one or more clips that, when the module is inserted into the connector housing, occupy corresponding retention apertures of the connector housing. Additionally, or alternatively, the different modules may clip or otherwise attach to one another—e.g., different modules may include complementary clips or other attachment features on their upper and lower faces, such that the modules are attachable together as a single stack.

It will be understood that a connector housing may include any suitable number of two or more insertion cavities for different cable wire modules, depending on the implementation. In this example, the sizes of the depicted cable wire modules 204A/B are such that each module would, when retained within the connector housing 206, occupy a single corresponding insertion cavity within the connector housing. However, in some embodiments, some cable wire modules are sized to occupy two or more corresponding insertion cavities. In general, each cable wire module is sized to occupy a positive integer number of insertion cavities.

FIG. 2B again shows cable connector assembly 200, including connector housing 206. In this example, each of the insertion cavities of the connector housing have been populated with various cable wire modules, including modules 204A and 204B. Thus, in this example, the cable connector serves as a male plug that can be used to couple the plurality of cable wires with other suitable cable wires (e.g., via a complementary female assembly), and/or suitable electric devices or components, such as PCBs.

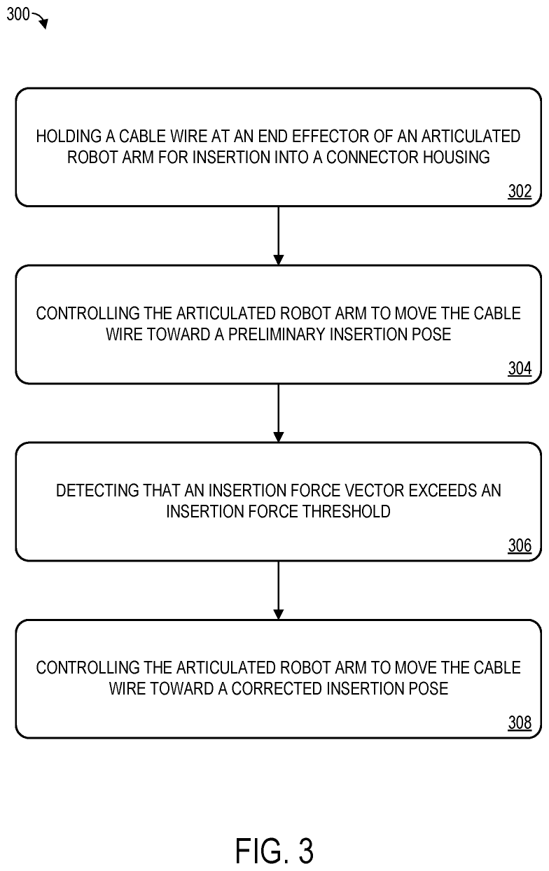

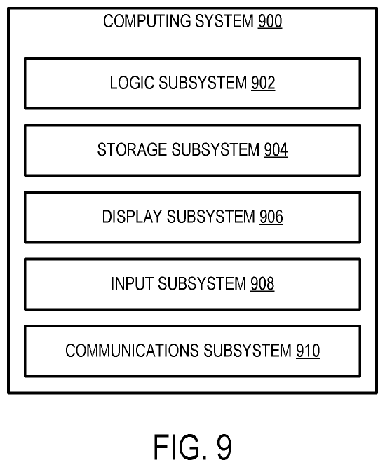

However, as discussed above, insertion of cable wires into connector housings can be a time consuming and inconsistent process. Furthermore, it is difficult to support various different cases where cable wires are inserted individually (e.g., as is shown in FIG. 1), inserted as cable wire modules (e.g., as is shown in FIGS. 2A and 2B), or inserted as other suitable arrangements not explicitly described herein. Accordingly, FIG. 3 illustrates an example method 300 for assembly of a cable connector. Steps of method 300 may be initiated, terminated, or repeated at any suitable time and in response to any suitable condition. Method 300 may be implemented as any suitable computing system of one or more computing devices. Any computing device implementing steps of method 300 may have any suitable capabilities, hardware configuration, and form factor. In some examples, method 300 may be implemented by computing system 900 described below with respect to FIG. 9.

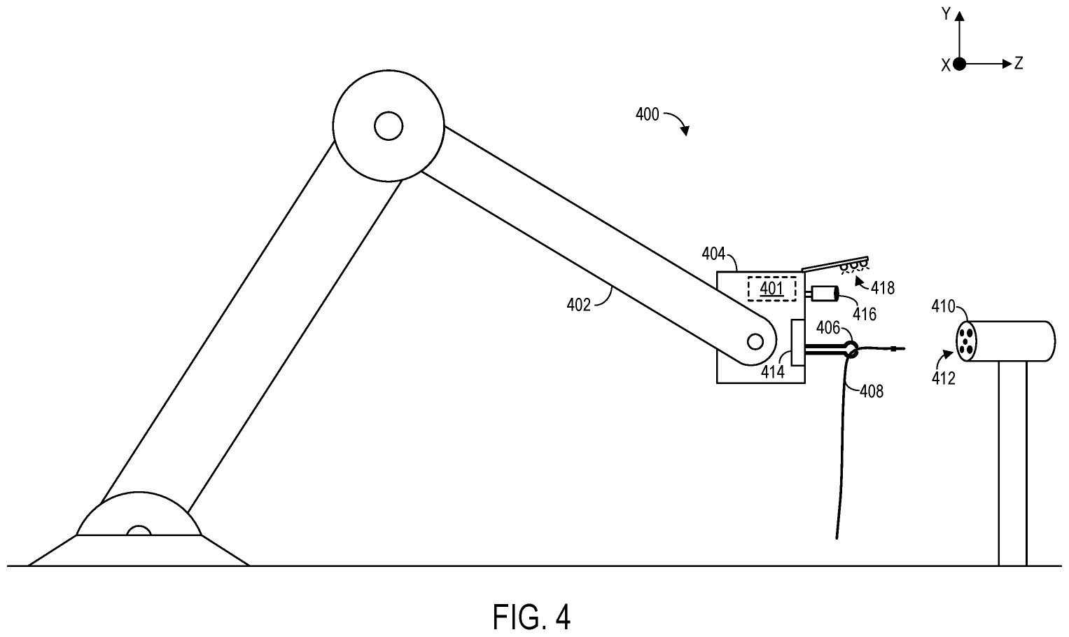

At 302, method 300 includes, an end effector affixed to an articulated robot arm of a robotic insertion system, holding a cable wire for insertion into an insertion cavity of a connector housing. This is schematically illustrated with respect to FIG. 4. In particular, FIG. 4 schematically shows an example robotic insertion system 400. It will be understood that robotic insertion system 400 is a non-limiting example, highly simplified, and schematic in nature.

As shown, robotic insertion system 400 includes a controller 401. The “controller” takes the form of any suitable computer logic hardware configured to execute software, firmware, and/or hardware-encoded instructions to thereby control operations of the robotic insertion system. For example, controller 401 may control movements of an articulated robot arm, gripping/releasing of cable wires by an end effector, operation of a camera system, operation of an illumination system (e.g., laser alignment system), etc. In this example, the controller is depicted as being “on-board” the robotic insertion system. It will be understood that, in some examples, the controller may be at least partially implemented in a housing or structure that is physically separate from the robotic insertion system, and may be communicatively coupled with the robotic insertion system via any suitable wired or wireless connection. In some examples, controller 401 performs one or more steps of method 300. In some examples, controller 401 is implemented as computing system 900 described below with respect to FIG. 9.

Robotic insertion system 400 includes an articulated robot arm 402. An “articulated robot arm” as described herein takes the form of any computer-controlled robotic mechanism suitable for manipulating physical objects (e.g., physical objects such as cable wires and/or cable wire modules) using an end effector. “Manipulating” can include translating and/or rotating the physical objects. Articulated robot arms have any suitable physical capabilities—e.g., range of motion, movement speed, insertion force, and/or weight capacity. In some examples, articulated robot arms have six or more degrees of freedom.

Articulated robot arm 402 is equipped with an end effector 404. In this example, the end effector refers to an assembly attached to the end of the articulated robot arm, and includes various sensors and tools that are moved through physical space by the articulated robot arm. In this example, the end effector includes a wire gripping tool 406 used to hold a cable wire 408 for insertion into a connector housing 410. Specifically, the cable wire is held for insertion into an insertion cavity 412 of the connector housing. In this example, the cable wire is inserted as a single cable wire held by a wire gripping tool of the end effector—e.g., similar to the cable connector design depicted in FIG. 1.

In this example, end effector 404 relies on friction between the prongs of wire gripping tool 406 and the cable wire to hold the cable wire in place. The pose of the end effector 404, and therefore the pose of the cable wire 408, is changed by movements of the articulated robot arm 402. It will be understood that this is only one simplified and non-limiting example of an end effector. In general, an “end effector” takes the form of any suitable mechanism or structure usable to physically hold and manipulate (e.g., translate and/or rotate) an object such as a cable wire. As non-limiting examples, end effectors may use friction, interlocking geometry, suction, adhesives, and/or magnetism to physically hold a cable wire during manipulation. In some examples, the articulated robot arm is configured to make use of two or more different end effectors—e.g., the end effectors may be dynamically swappable, and/or two or more end effectors may be affixed to the articulated robot arm at once.

In some examples, the end effector includes one or more mechanisms that are controlled by a computing system (e.g., the controller of the robotic insertion system) to hold and/or release a cable insert module. For instance, in the example of FIG. 4, a distance between the prongs of the wire gripping tool 406 is adjustable by the controller, which enables computerized control over gripping and releasing of the cable wire 408. In other examples, however, an end effector may be purely mechanical in nature. For instance, in some examples, the end effector relies on springs, interlocking geometry, suction cups, magnets, and/or other suitable tools to temporarily retain the cable wire, until a retention force of the end effector is overcome by an external force (such as friction between the cable wire and the interior of the connector housing).

An end effector may pick up (or otherwise begin manipulating) cable wires in any suitable way. In some examples, the cable wire is placed in or on the end effector by a human operator. Additionally, or alternatively, loading of cable wire into the robotic insertion system may be at least partially automated. For instance, in one example scenario, the robotic insertion system uses computer vision to recognize a cable wire, controls movements of the robotic arm to place the end effector at a pose conducive to receiving the cable wire, controls the end effector (e.g., by controlling a gripping tool) to hold the cable wire, then performs automated insertion of the cable wire into a connector housing, as will be described in more detail below. In another example scenario, the robotic insertion system controls the robotic arm to move the end effector to a predefined initial pose to which cable wires are delivered (e.g., by another robotic arm, by a human operator, by a mechanism such as a conveyor belt), and then begins the automated insertion process upon some condition being met. Suitable conditions may include, as examples, passage of a predefined length of time, detection of a force consistent with the arrival of a cable wire, detection of the presence of a cable wire via a computer vision system, and/or detection of the presence of a cable wire in any other suitable way.

In the example of FIG. 4, the end effector 404 is already holding the cable wire, and the end effector 404 is already positioned near, and oriented toward, the connector housing 410. In some examples, a human operator controls movement of the end effector (e.g., by controlling the robot arm, or by holding and moving the end effector) to put the end effector in rough alignment with the connector housing. For instance, a human operator may roughly align the end effector with the connector housing before, during, or after placing a cable wire in or on the end effector. Additionally, or alternatively, the robotic insertion system is in some examples configured to automatically align itself with the connector housing before, during, or after receiving a cable wire—e.g., based on a known pose of the connector housing relative to a coordinate system of the robotic insertion system, and/or based on detection of the connector housing (such as via computer vision).

Robotic insertion system 400 additionally includes a force sensor 414. The force sensor is configured to detect an insertion force vector of the end effector 404 during an attempt to insert the cable wire 408 into the connector housing 410. As will be described in more detail below, detection of an insertion force vector via a force sensor is usable to detect misalignments between the cable wire and connector housing that are preventing successful insertion of the cable wire. The force sensor is configured to output force readings with any suitable degree of precision. In some examples, the force sensor outputs force readings having three degrees-of-freedom (3-DOF)—e.g., x, y, and z coordinates for the direction of the force vector. In some examples, the force sensor outputs six degrees-of-freedom (6-DOF) insertion vectors—e.g., x-direction, y-direction, z-direction, x-rotation, y-rotation, z-rotation.

Furthermore, in this example, the robotic insertion system includes a camera system 416. In some cases, the camera system of the robotic insertion system may be used to capture one or more images of the connector housing prior to insertion of the cable wire. In general, a robotic insertion system as described herein may include a camera system of one or more suitable cameras, where each suitable camera may be sensitive to any suitable wavelengths of electromagnetic radiation, and have any suitable image-capture capabilities, including resolution, frame rate, and/or field-of-view.

As one example, the camera system may include one or more red green blue (RGB) cameras, which are sensitive to visible wavelengths of light and output RGB images. In some examples, the camera system may include one or more depth cameras in addition to, or instead of, RGB cameras and/or other suitable cameras. Depth cameras are configured to output depth images, where pixels of the depth images encode the detected distances between the image sensor of the depth camera and physical objects in the surrounding environment. Any suitable depth-sensing technology may be used—e.g., stereoscopic, structured light, or time-of-flight.

In examples where both RGB and depth cameras are used, they may in some cases be used together as an integrated camera module. As one non-limiting example, an Intel® RealSense™ camera system may be used, which includes both RGB and depth camera modules together in a known alignment, and outputs both RGB and depth image data. As another example, a stereo pair of RGB cameras may be used in addition to, or instead of, a depth camera.

Robotic insertion system 400 additionally includes an illumination system 418. The illumination system may be used to illuminate at least a portion of the connector housing while one or more images of the connector housing are captured using the camera system. The illumination system may emit any suitable wavelength and intensity of light. Furthermore, such light may be emitted with any suitable spatial pattern.

In some examples, either or both of the camera system and illumination system are independently movable/steerable relative to the articulated robot arm. For example, either or both of the camera system and illumination system may be attached to the articulated robot arm via motorized gimbals, such that movements of the camera system/illumination system may be controlled independently of the articulated robot arm. Additionally, or alternatively, the camera system and/or illumination system may be statically affixed to the articulated robot arm—e.g., the pose of the camera system and/or illumination system is only changed via movements of the articulated robot arm and/or end effector to which they are attached.

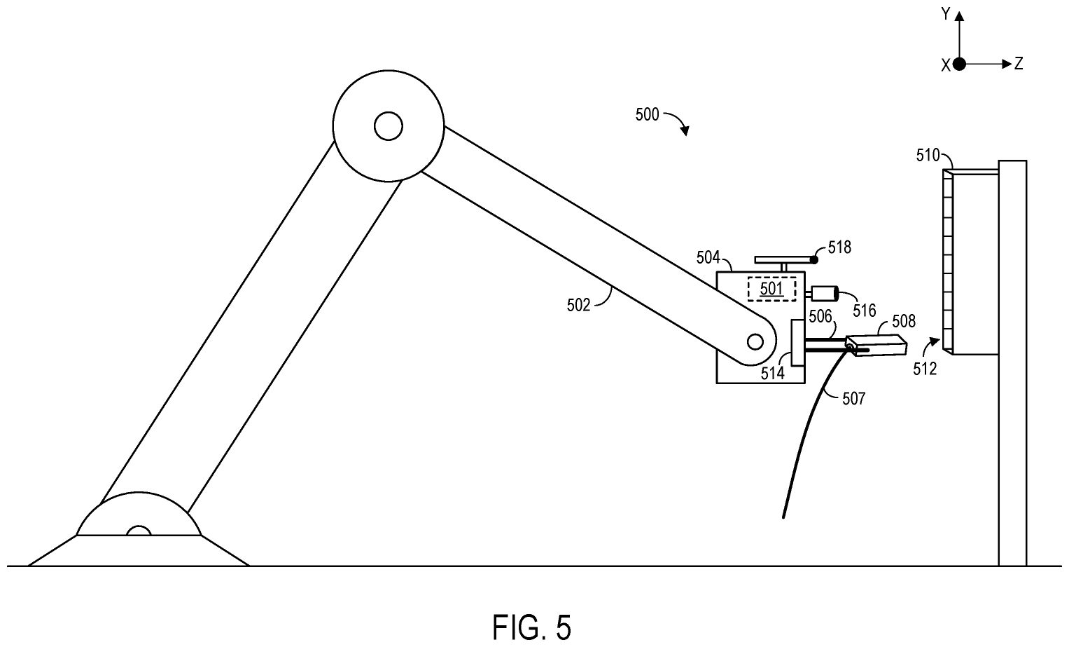

FIG. 5 schematically shows another example robotic insertion system 500. Many of the components of robotic insertion system 500 are similar to those of robotic insertion system 400. For instance, robotic insertion system 500 includes a controller 501, an articulated robot arm 502, and an end effector 504. However, in this example, the end effector includes a module gripping tool 506. FIG. 5 schematically shows a cable wire 507, which in this example is inserted into a cable wire module 508. The cable wire module is held by the module gripping tool 506 of the end effector for insertion into a connector housing 510. In this example, the connector housing is a modular connector housing having a plurality of insertion cavities, one of which is labeled as insertion cavity 512. Each insertion cavity takes the form of a notch or shelf useable to retain a cable wire module within the connector housing.

In this example, the wire gripping tool of FIG. 4 differs from the module gripping tool of FIG. 5. However, it will be understood that this need not always be the case. For instance, in some examples, the end effector may be equipped with one gripping tool tool useable for both individual cable wires and cable wire modules. Additionally, or alternatively, the end effector may be equipped with multiple different gripping tool tools (e.g., for different cable wire arrangements), and/or the articulated robot arm may enable swapping between different end effectors having different gripping capabilities.

Continuing with FIG. 5, robotic insertion system 500 additionally includes a force sensor 514 and a camera system 516, which may be similar to force sensor 414 and camera system 416 described above with respect to FIG. 4. Additionally, robotic insertion system 500 includes a laser alignment system 518. As will be described in more detail below, the camera system may in some cases be used to capture one or more images while the laser alignment system emits laser light toward the connector housing. Such images may in some cases be used in determining the preliminary insertion pose, toward which the articulated robot arm will move the cable wire. It will be understood that laser alignment systems may be used in cases where cable wires are inserted individually (e.g., as is shown in FIG. 4), in cases where cable wires are inserted as cable wire modules (e.g., as is shown in FIG. 5), or may be omitted entirely, depending on the implementation. Similar to the illumination system 418 described above, laser alignment system 518 may emit any suitable type, intensity, and pattern of illumination light toward the connector housing, and may be activated or deactivated at any suitable time and in response to any suitable condition.

Returning briefly to FIG. 3, at 304, method 300 includes controlling the articulated robot arm to move the cable wire toward a preliminary insertion pose predicted to correspond to insertion of the cable wire into the robotic insertion system. This preliminary insertion pose may be determined in any suitable way. In some examples, the preliminary insertion pose is determined using machine vision techniques based on images captured by a camera system. For instance, as discussed above, the robotic insertion system may include a suitable camera system configured to capture images of the connector housing. The preliminary insertion pose may then be determined based at least in part on the captured images. In some cases, one or more of the images may be captured while the connector housing is illuminated by a laser alignment system of the robotic insertion system.

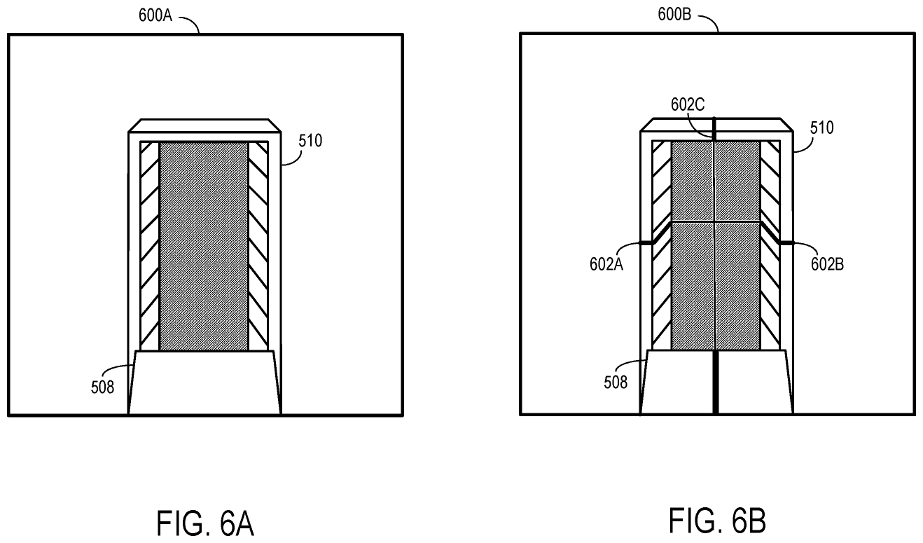

This is schematically illustrated with respect to FIGS. 6A and 6B, showing example images 600A and 600B captured by camera system 516 of robotic insertion system 500. In FIG. 6A, the cable wire module 508 and connector housing 510 are visible in image 600A. In FIG. 6B, the laser alignment system 518 has been activated and is now emitting laser illumination light toward the connector housing. This has resulted in visible laser glints 602A, 602B, and 602C in image 600B. Based on these images, and the positions of the laser glints in image 600B, the robotic insertion system may determine a preliminary insertion pose for the cable wire module, predicted to correspond to successful insertion of the cable wire module into the connector housing.

This may be done through any suitable image processing techniques. In one non-limiting example approach, the robotic insertion system employs image processing to detect a segmented image region and a virtual plane related to a connector housing within the captured images. This process is used to guide the articulated robot arm for the precise insertion of the cable wire module. First, image processing techniques are utilized to differentiate the connector housing from its surroundings and establish a virtual plane parallel to the connector housing's surface, facilitating the identification of a preliminary insertion pose corresponding to correct insertion of the cable wire module. These techniques include the subtraction of pixel values between images captured under varying illumination conditions, notably with and without a laser alignment system activated, to enhance the visibility of specific features of the connector housing. This approach enables the robotic insertion system to accurately align and insert the cable wire module by identifying a suitable preliminary insertion pose based on the segmented image region and virtual plane. It will be understood that the present disclosure is agnostic as to the specific manner in which the preliminary insertion pose is determined, but rather is focused on accounting for misalignments using force feedback.

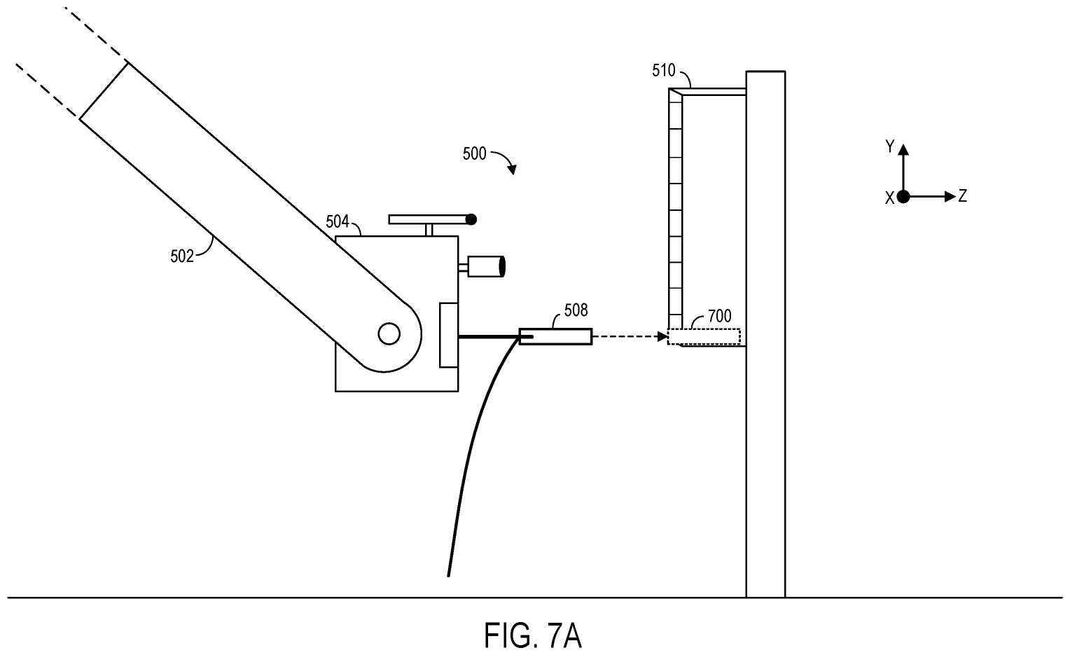

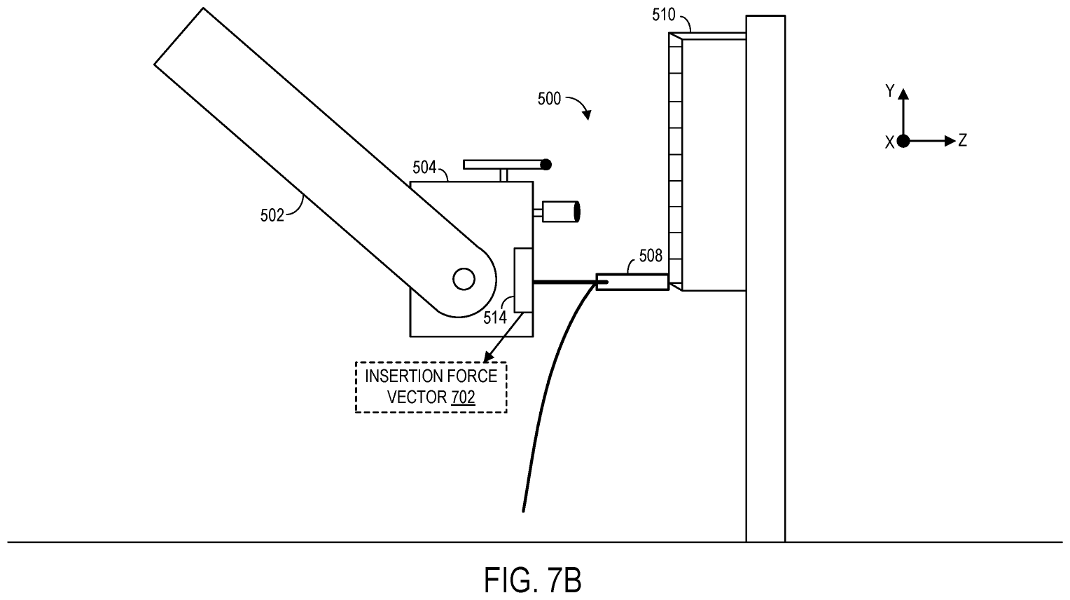

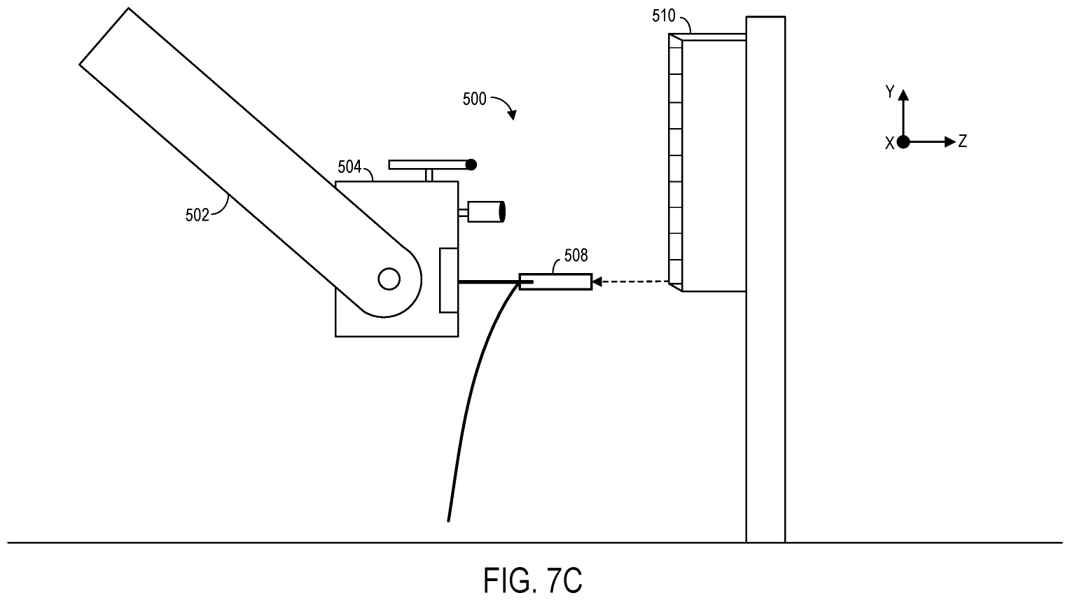

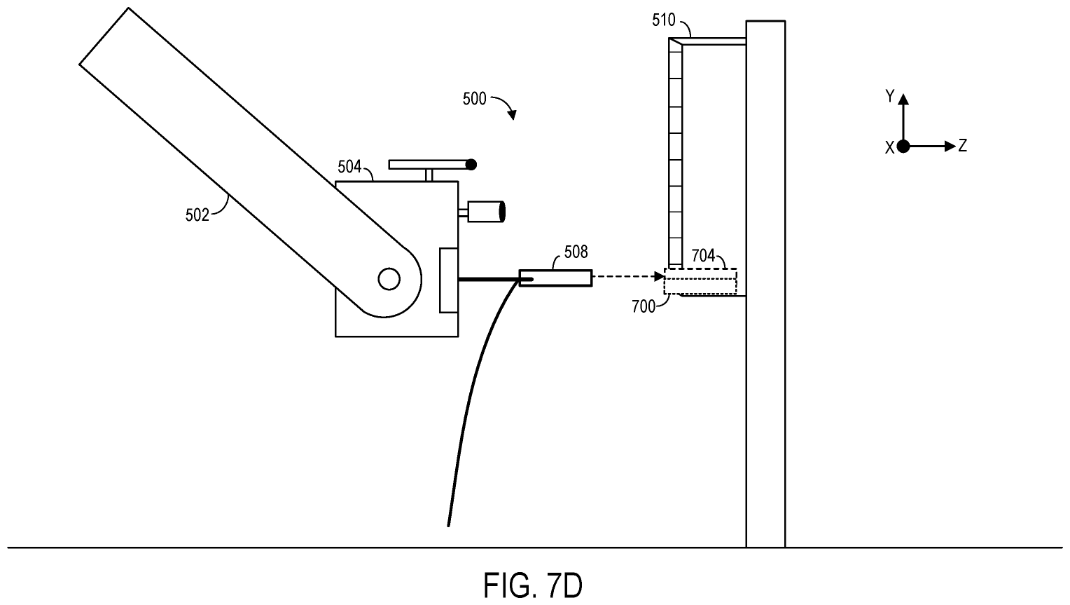

In any case, once the preliminary insertion pose is determined, the articulated robot arm is controlled to move the cable wire toward the connector housing. This process is schematically illustrated with respect to FIGS. 7A-D. Specifically, FIG. 7A again shows aspects of robotic insertion system 500 of FIG. 5, while FIGS. 7A-D show a scenario where the cable wire is inserted as part of a cable wire module. It will be understood that the techniques described herein are equally applicable to scenarios where the cable wire is inserted as an individual cable wire, such as is shown in FIG. 4. In FIG. 7A, a preliminary insertion pose 700 has been determined relative to connector housing 510, which is predicted to correspond to successful insertion of the cable wire module 508 into the connector housing. Thus, the articulated robot arm is controlled to move the cable wire module toward the preliminary insertion pose.

However, various potential misalignments in the robotic insertion system can result in unsuccessful insertion of the cable wire into the connector housing. This may include, for instance, misalignments of the articulated robot arm, of the end effector, of the gripping tool used to hold the cable wire, of a camera system used to capture images of the connector housing, etc. Any or all of these misalignments can potentially result in a scenario where, while moving toward the preliminary insertion pose, the cable wire (or cable wire module) impacts the connector housing, or other surface, instead of being inserted into the insertion cavity. This scenario is schematically illustrated in FIG. 7B, where cable wire module 508 has impacted a surface of the connector housing 510, and thus has not been successfully inserted into the insertion cavity.

Accordingly, returning briefly to FIG. 3, at 306, method 300 includes detecting, from a force sensor of the robotic insertion system, that a magnitude of an insertion force vector exceeds an insertion force threshold. This indicates misalignment of the cable wire relative to the insertion cavity. Returning briefly to FIG. 7B, the force sensor 514 of robotic insertion system 500 outputs an insertion force vector 702, which quantifies a force experienced at the force sensor due to the articulated robot arm pushing the cable wire module against the surface of the connector housing. The insertion force vector may include a magnitude of the force, and a direction along which the force is applied.

The insertion force threshold takes any suitable form depending on the implementation. Relatively lower insertion force thresholds may result in more sensitivity to potential misalignments, and can therefore reduce the risk of inadvertent damage to the cable wires and/or connector housings. Relatively higher insertion force thresholds can reduce the risk of false positives (e.g., interrupting insertion attempts that were likely to succeed). In some cases, the insertion force threshold may be determined based on the types of materials used for constructing the connector housing (e.g., how fragile the material is), the amount of resistance normally experienced during successful insertion for a given cable connector type, and/or any other suitable criteria.

In some examples, after detecting that the insertion force threshold has been exceeded, the robotic insertion system may control the robot arm to retract the cable wire away from the connector housing prior to moving the cable wire toward a corrected insertion pose. This is schematically illustrated with respect to FIG. 7C, where the articulated robot retracts the cable wire module away from the connector housing. This may beneficially pull the cable wire back to a “safe” location for further repositioning—e.g., reducing the likelihood that attempting to reposition the cable wire near the connector housing will result in further impacts between the cable wire and connector housing.

Returning briefly to FIG. 3, at 308, method 300 includes controlling the articulated robot arm to move the cable wire toward a corrected insertion pose determined based at least in part on the insertion force vector. This is schematically illustrated with respect to FIG. 7D, where the articulated robot arm is controlled to move the cable wire module toward a corrected insertion pose 704, having a different position from the preliminary insertion pose 700. This difference between the preliminary insertion pose and the corrected insertion pose represents a pose adjustment. The specific distance and direction in which the pose adjustment is made may take any suitable form, and may be determined by the robotic insertion system in any suitable way.

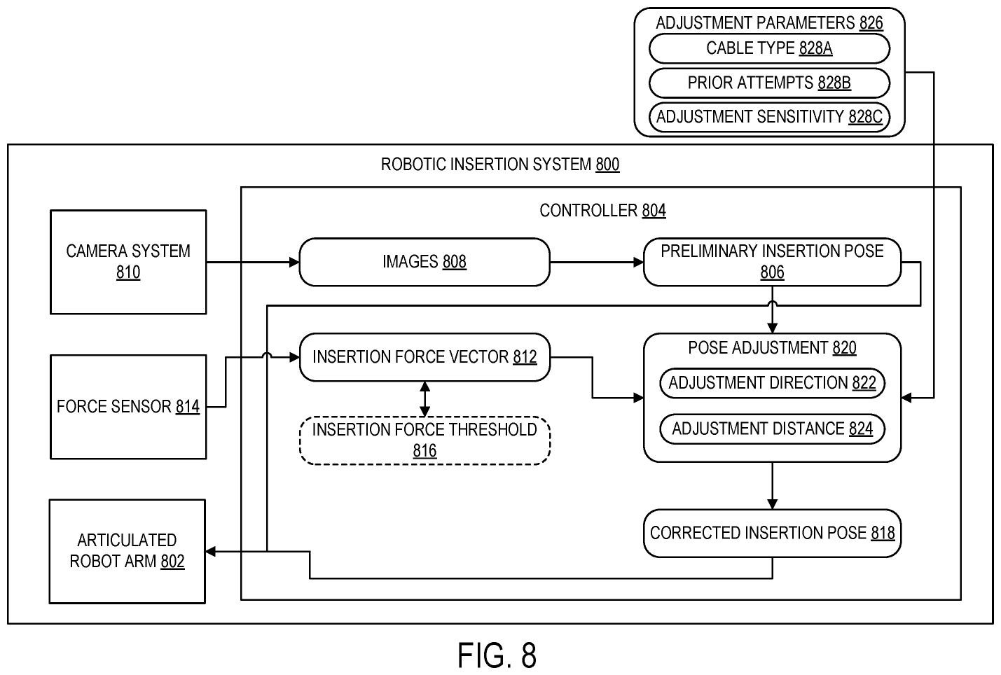

Insertion pose correction is schematically illustrated with respect to FIG. 8, showing an example robotic insertion system 800. The robotic insertion system includes an articulated robot arm 802, controlled by a controller 804. As discussed above, the controller takes the form of any suitable computer hardware logic components useable to implement the robotic insertion techniques described herein. In some examples, robotic insertion system 800 and controller 804 may be implemented as computing system 900 described below with respect to FIG. 9.

Robotic insertion system 800 determines a preliminary insertion pose 806, and controls the articulated robot arm 802 to move a cable wire toward the preliminary insertion pose. As discussed above, the preliminary insertion pose is determined in any suitable way. In this example, the controller receives images 808 from a camera system 810, where the images depict a connector housing into which the cable wire is to be inserted. Through image processing, the controller determines a preliminary insertion pose relative to the connector housing, which is predicted to correspond to successful insertion of the cable wire into the connector housing.

During the insertion attempt, the controller receives an insertion force vector 812 from a force sensor 814 of the robotic insertion system. The insertion force vector takes any suitable form. In some examples, the insertion force vector includes a magnitude of the current detected force, and a direction in which the force is applied. Furthermore, the insertion force vector may be reported with any suitable frequency. As one example, the insertion force vector may be continuously reported—e.g., whenever the robotic insertion system is powered on, and/or whenever the articulated robot arm is being moved. In some examples, the insertion force vector is only reported upon a magnitude of the insertion force vector exceeding a threshold, which may indicate a problem with the insertion process.

The insertion force vector is compared to an insertion force threshold 816 to evaluate the success of the insertion process. If the magnitude of the insertion force vector exceeds the insertion force threshold, the controller determines a corrected insertion pose 818, and controls the articulated robot arm to move the cable wire toward the corrected insertion pose. The preliminary insertion pose and corrected insertion pose differ by a pose adjustment 820, which includes an adjustment direction 822 and an adjustment distance 824.

Each of the adjustment direction and adjustment distance may be determined in any suitable way. In some examples, the direction of the pose adjustment is determined based at least in part on a direction of the insertion force vector. For instance, if a misalignment causes a cable wire module to catch on a left side of the connector housing, then a direction of the insertion force vector will likely point to the right. Similarly, in cases where the cable wire is inserted as an individual cable wire (e.g., without a cable wire module), then the insertion force vector will likely point in the direction of the bent wire. Thus, determining the corrected insertion pose may include translating the preliminary insertion pose in the direction of the insertion force vector.

In some examples, the distance of the pose adjustment may be predetermined. For instance, the robotic insertion system may shift the preliminary insertion pose by a fixed amount, such as 1 mm, per attempt. In other examples, however, the distance of the pose adjustment is dynamically determined based at least in part on one or more adjustment parameters. This is schematically shown in FIG. 8, where the controller receives a plurality of adjustment parameters 326. An “adjustment parameter” may include any of a wide variety of different types of information that may be relevant to the distance of the pose adjustment.

As non-limiting examples, the adjustment parameters may include an indication of whether the cable wire is inserted as a single wire or as part of a cable wire module (e.g., cable type parameter 828A), a quantity of prior insertion attempts for the cable wire (e.g., prior attempts parameter 828B), and an adjustment sensitivity parameter (e.g., adjustment sensitivity parameter 828C). Any or all of these factors may be weighted and considered when determining the distance of the pose adjustment. For instance, in some examples, insertion poses may be adjusted by relatively larger (or smaller) amounts depending on whether an individual cable wire, or cable wire module, is being inserted—e.g., depending on the relative dimensions of the components, the material types of the connector housing and cable wire module, etc. In some examples, the distance of the pose adjustment may be changed by relatively smaller (or larger) amounts as more subsequent insertion attempts are made. In some cases, the distance of the pose adjustment may be influenced by an adjustment sensitivity parameter, set by a human operator to increase or decrease the amount by which each adjustment is made. It will be understood that these examples are non-limiting, and that a variety of different factors may be considered in determining the corrected insertion pose.

In any case, once the corrected insertion pose is determined, the articulated robot arm is controlled to move the cable wire toward the corrected insertion pose. In some cases, this may result in successful insertion of the cable wire. In other cases, the subsequent insertion attempt based on the corrected insertion pose may again be unsuccessful—e.g., causing the cable wire to impact the connector housing. As discussed above, such an unsuccessful insertion attempt may be detected by receiving an insertion force vector that exceeds an insertion force threshold. At this time, the controller may determine a subsequent corrected insertion pose, differing from the corrected insertion pose by a subsequent pose adjustment. This process may be repeated any suitable number of times, until successful insertion is achieved (e.g., as indicated by an insertion attempt that does not exceed the insertion force threshold), or another exit condition being reached (e.g., a maximum number of insertion attempts, detection of an error condition, manual stopping by a human operator, etc.).

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 9 schematically shows a simplified representation of a computing system 900 configured to provide any to all of the compute functionality described herein. Computing system 900 may take the form of one or more network-accessible devices, personal computers, server computers, mobile computing devices, and/or other computing devices.

Computing system 900 includes a logic subsystem 902 and a storage subsystem 904. Computing system 900 may optionally include a display subsystem 906, input subsystem 908, communication subsystem 910, and/or other subsystems not shown in FIG. 9.

Logic subsystem 902 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 904 includes one or more physical devices configured to temporarily and/or permanently hold computer information, such as data and instructions executable by the logic subsystem. When the storage subsystem includes two or more devices, the devices may be collocated and/or remotely located. Storage subsystem 904 may include volatile, nonvolatile, dynamic, static, read/write, read-only, random-access, sequential-access, location-addressable, file-addressable, and/or content-addressable devices. Storage subsystem 904 may include removable and/or built-in devices. When the logic subsystem executes instructions, the state of storage subsystem 904 may be transformed—e.g., to hold different data.

Aspects of logic subsystem 902 and storage subsystem 904 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

When included, display subsystem 906 may be used to present a visual representation of data held by storage subsystem 904. This visual representation may take the form of a graphical user interface (GUI). Display subsystem 906 may include one or more display devices utilizing virtually any type of technology. In some implementations, display subsystem may include one or more virtual-, augmented-, or mixed reality displays.

When included, input subsystem 908 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 910 may be configured to communicatively couple computing system 900 with one or more other computing devices. Communication subsystem 910 may include wired and/or wireless communication devices compatible with one or more different communication protocols. The communication subsystem may be configured for communication via personal-, local- and/or wide-area networks.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

In an example, a method for assembly of a cable connector comprises: holding a cable wire for insertion into an insertion cavity of a connector housing using an end effector affixed to an articulated robot arm of a robotic insertion system; controlling the articulated robot arm to move the cable wire toward a preliminary insertion pose predicted to correspond to insertion of the cable wire into the insertion cavity; detecting, from a force sensor of the robotic insertion system, that a magnitude of an insertion force vector exceeds an insertion force threshold, indicating misalignment of the cable wire relative to the insertion cavity; and controlling the articulated robot arm to move the cable wire toward a corrected insertion pose determined based at least in part on the insertion force vector, wherein the preliminary insertion pose and the corrected insertion pose differ by a pose adjustment. In this example or any other example, an adjustment direction of the pose adjustment is determined based at least in part on a vector direction of the insertion force vector. In this example or any other example, an adjustment distance of the pose adjustment is dynamically determined based at least in part on one or more adjustment parameters. In this example or any other example, the one or more adjustment parameters include an indication of whether the cable wire is inserted as a single wire or as a portion of a cable wire module. In this example or any other example, the one or more adjustment parameters include a quantity of prior insertion attempts for the cable wire. In this example or any other example, the one or more adjustment parameters include an adjustment sensitivity parameter. In this example or any other example, the method further comprises controlling the robot arm to retract the cable wire away from the connector housing prior to moving the cable wire toward the corrected insertion pose. In this example or any other example, the cable wire is inserted as a single cable wire held by a wire gripping tool of the end effector. In this example or any other example, the cable wire is one of one or more cable wires inserted into a cable wire module, and wherein the cable wire module is held by a module gripping tool of the end effector. In this example or any other example, the method further comprises, via a camera system of the robotic insertion system, capturing one or more images of the connector housing, and wherein the preliminary insertion pose is identified based at least in part on the one or more images. In this example or any other example, at least one of the one or more images is captured while the connector housing is illuminated by a laser alignment system of the robotic insertion system.

In an example, a robotic insertion system comprises: an articulated robot arm equipped with an end effector; a force sensor; and a controller configured to: while a cable wire is held by the end effector, control the articulated robot arm to move the cable wire toward a preliminary insertion pose predicted to correspond to insertion of the cable wire into an insertion cavity; detect, from the force sensor, that a magnitude of an insertion force vector exceeds an insertion force threshold, indicating misalignment of the cable wire relative to the insertion cavity; and control the articulated robot arm to move the cable wire toward a corrected insertion pose determined based at least in part on the insertion force vector, wherein the preliminary insertion pose and the corrected insertion pose differ by a pose adjustment. In this example or any other example, a direction of the pose adjustment is determined based at least in part on a direction of the insertion force vector. In this example or any other example, a distance of the pose adjustment is dynamically determined based at least in part on one or more adjustment parameters. In this example or any other example, the one or more adjustment parameters include an indication of whether the cable wire is inserted as a single wire or as a portion of a cable wire module. In this example or any other example, the one or more adjustment parameters include a quantity of prior insertion attempts for the cable wire. In this example or any other example, the one or more adjustment parameters include an adjustment sensitivity parameter. In this example or any other example, the cable wire is inserted as a single cable wire held by a wire gripping tool of the end effector. In this example or any other example, the cable wire is one of one or more cable wires inserted into a cable wire module, and wherein the cable wire module is held by a module gripping tool of the end effector.

In an example, a method for assembly of a cable connector comprises: holding a cable wire for insertion into an insertion cavity of a connector housing using an end effector affixed to an articulated robot arm of a robotic insertion system; capturing one or more images of the connector housing via a camera system of the robotic insertion system; controlling the articulated robot arm to move the cable wire toward a preliminary insertion pose predicted to correspond to insertion of the cable wire into the insertion cavity, wherein the preliminary insertion pose is identified based at least in part on the one or more images; detecting, from a force sensor of the robotic insertion system, that a magnitude of an insertion force vector exceeds an insertion force threshold, indicating misalignment of the cable wire relative to the insertion cavity; and controlling the articulated robot arm to move the cable wire toward a corrected insertion pose determined based at least in part on the insertion force vector, wherein the preliminary insertion pose and the corrected insertion pose differ by a pose adjustment, and wherein the pose adjustment is dynamically determined based at least in part on one or more adjustment parameters.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for assembly of a cable connector, the method comprising:
holding a cable wire for insertion into an insertion cavity of a connector housing using an end effector affixed to an articulated robot arm of a robotic insertion system;
controlling the articulated robot arm to move the cable wire toward a preliminary insertion pose predicted to correspond to insertion of the cable wire into the insertion cavity;
detecting, from a force sensor of the robotic insertion system, that a magnitude of an insertion force vector exceeds an insertion force threshold, indicating misalignment of the cable wire relative to the insertion cavity; and
controlling the articulated robot arm to move the cable wire toward a corrected insertion pose determined based at least in part on the insertion force vector, wherein the preliminary insertion pose and the corrected insertion pose differ by a pose adjustment.

2. The method of claim 1, wherein an adjustment direction of the pose adjustment is determined based at least in part on a vector direction of the insertion force vector.

3. The method of claim 1, wherein an adjustment distance of the pose adjustment is dynamically determined based at least in part on one or more adjustment parameters.

4. The method of claim 3, wherein the one or more adjustment parameters include an indication of whether the cable wire is inserted as a single wire or as a portion of a cable wire module.

5. The method of claim 3, wherein the one or more adjustment parameters include a quantity of prior insertion attempts for the cable wire.

6. The method of claim 3, wherein the one or more adjustment parameters include an adjustment sensitivity parameter.

7. The method of claim 1, further comprising controlling the robot arm to retract the cable wire away from the connector housing prior to moving the cable wire toward the corrected insertion pose.

8. The method of claim 1, wherein the cable wire is inserted as a single cable wire held by a wire gripping tool of the end effector.

9. The method of claim 1, wherein the cable wire is one of one or more cable wires inserted into a cable wire module, and wherein the cable wire module is held by a module gripping tool of the end effector.

10. The method of claim 1, further comprising, via a camera system of the robotic insertion system, capturing one or more images of the connector housing, and wherein the preliminary insertion pose is identified based at least in part on the one or more images.

11. The method of claim 10, wherein at least one of the one or more images is captured while the connector housing is illuminated by a laser alignment system of the robotic insertion system.

12. A robotic insertion system, comprising:
an articulated robot arm equipped with an end effector;
a force sensor; and
a controller configured to:
while a cable wire is held by the end effector, control the articulated robot arm to move the cable wire toward a preliminary insertion pose predicted to correspond to insertion of the cable wire into an insertion cavity;
detect, from the force sensor, that a magnitude of an insertion force vector exceeds an insertion force threshold, indicating misalignment of the cable wire relative to the insertion cavity; and
control the articulated robot arm to move the cable wire toward a corrected insertion pose determined based at least in part on the insertion force vector, wherein the preliminary insertion pose and the corrected insertion pose differ by a pose adjustment.

13. The robotic insertion system of claim 12, wherein a direction of the pose adjustment is determined based at least in part on a direction of the insertion force vector.

14. The robotic insertion system of claim 12, wherein a distance of the pose adjustment is dynamically determined based at least in part on one or more adjustment parameters.

15. The robotic insertion system of claim 14, wherein the one or more adjustment parameters include an indication of whether the cable wire is inserted as a single wire or as a portion of a cable wire module.

16. The robotic insertion system of claim 14, wherein the one or more adjustment parameters include a quantity of prior insertion attempts for the cable wire.

17. The robotic insertion system of claim 14, wherein the one or more adjustment parameters include an adjustment sensitivity parameter.

18. The robotic insertion system of claim 12, wherein the cable wire is inserted as a single cable wire held by a wire gripping tool of the end effector.

19. The robotic insertion system of claim 12, wherein the cable wire is one of one or more cable wires inserted into a cable wire module, and wherein the cable wire module is held by a module gripping tool of the end effector.

20. A method for assembly of a cable connector, the method comprising:
holding a cable wire for insertion into an insertion cavity of a connector housing using at an end effector affixed to an articulated robot arm of a robotic insertion system;
capturing one or more images of the connector housing via a camera system of the robotic insertion system;
controlling the articulated robot arm to move the cable wire toward a preliminary insertion pose predicted to correspond to insertion of the cable wire into the insertion cavity, wherein the preliminary insertion pose is identified based at least in part on the one or more images;
detecting, from a force sensor of the robotic insertion system, that a magnitude of an insertion force vector exceeds an insertion force threshold, indicating misalignment of the cable wire relative to the insertion cavity; and
controlling the articulated robot arm to move the cable wire toward a corrected insertion pose determined based at least in part on the insertion force vector, wherein the preliminary insertion pose and the corrected insertion pose differ by a pose adjustment, and wherein the pose adjustment is dynamically determined based at least in part on one or more adjustment parameters.
